(19) United States
(12) Patent Application Publication
(10) Pub. No.: US 2008/0320048 A1
(43) Pub. Date: Dec. 25, 2008

(54) AUTOMATED COMPOSITION OF SERVICES IN A PLATFORM

(75) Inventors: Freddy LECUE, Rennes (FR); Alexandre Delteil, Meudon (FR)

Correspondence Address: LOWE HAUPTMAN HAM & BERNER, LLP, 1700 DIAGONAL ROAD, SUITE 300, ALEXANDRIA, VA, 22314, US

(73) Assignee: France Telecom, Paris (FR)

(21) Appl. No.: 12/122,101

(22) Filed: May 16, 2008

(30) Foreign Application Priority Data
May 18, 2007 (FR) 0755127

(51) Int. Cl. G06F 17/30

(52) U.S. Cl. 707/104.1; 707/E17.005

(57) ABSTRACT

In a platform, a composed Web service having predetermined inputs and outputs is automatically composed from a set of component Web services stored in a database. Each component Web service comprises at least one input and at least one output associated with textual representations. The method of the invention comprises selecting a component service having outputs semantically corresponding to all the predetermined outputs, selecting a component service having all the inputs semantically corresponding to predetermined inputs, and composing said composed service with the selected component services.

### RELATED APPLICATIONS

The present application is based on, and claims priority from, French Application Number 0755127, filed May 18, 2007, the disclosure of which is hereby incorporated by reference herein in its entirety.

### BACKGROUND OF THE INVENTION

1—Field of the Invention

The present invention relates to an automated composition of services in a platform.

More particularly, the invention deals with the composition of a Web service desired by a customer in a platform, the Web service having to be composed from available component Web services.

2—Description of the Prior Art

A Web service, or any other service, is considered as a process accessible on the Web requiring inputs and supplying outputs dependent on the inputs. These inputs and these outputs are semantically annotated according to a defined Web specification, such as the RDF (Resource Description Framework) or OWL (Web Ontology Language) specification, in order to be understandable and accessible to Web resource processing devices, such as servers or terminals. In other words, the inputs and the outputs of the Web services are respectively associated with semantic information such as input concepts and output concepts, a concept being a textual representation in the form of a word or a sequence of words. A concept is part of a set of words or a sequence of words representing common meaningful characteristics. The concepts of a particular set are combined in an ontology and are connected according to a particular taxonomy. A specific semantic domain comprises one or more ontologies. Examples of Web services with input and output concepts connected by ontologies are illustrated in FIGS. 5a to 5e and in FIG. 6, and relate to the semantic domain of the cinema.

The automated composition of Web services involves using a set of existing and available Web services with semantically annotated inputs and outputs to form a more specific and precise service satisfying the requirements of semantic compatibility between the component services.

Current efforts in the area of the automated composition of Web services are mainly focused on the mapping between the input concepts and the output concepts of the available services. The main methods determine compatibilities between services according to the semantic proximity of the output concepts of a service to the input concepts of other services.

Referring to FIG. 1, a known technique for composing Web services is to construct a chart of services oriented and weighted on the basis of a list of services Sₛ, with 1≦s≦S. The input and output concepts concern a specific semantic domain and are connected to each other according to one or more simple hierarchical organizations called as taxonomies. In FIG. 1, the input concepts and the output concepts of the chart G respectively correspond to the inputs I1 to I3 and to the outputs O1 to O4 of the service to be composed. In such a chart, each available service S1 to S3 is likened to a node. There is an edge between two nodes Ss and S3, if the input concept associated with an input, for example the input I_{S,1}, of the service Ss is semantically close to the output concept associated with an output, O_{3,1}, of the service S3. The input concepts of a service can correspond to output concepts of different services; for example, the input concept associated with the input I_{S,2} of the service S_{S} corresponds to the output concept associated with the output O_{2,3} of the service S2. Each edge is labeled by one or more service quality variables such as time, cost, reliability and/or confidence relative to each of the two services linked by the edge, and by a concept proximity variable. The service composition amounts to searching for the shortest path in the chart G between the inputs I1 to I3 and the outputs O1 to O4 relating to the service to be composed.

This chart can be likened to a point-to-point composition mapping to each input of a first service an output of a second service semantically close to the first service. Such a known method of composing services determines all the possible semantic proximities between the concept of an input of a service and that of an output of another service which leads to the implementation of a complex and costly algorithm because of the large number of services involved and their inputs and outputs.

Furthermore, the services offered to users by the Internet are very volatile and changeable. If too many of them are incorporated in a composition, they rapidly make the composition inoperable by an end user.

By determining all the possible composed services, including the most complex, the known method of composing services does not distinguish the simplest composed services among the set of composed services that it determines.

### SUMMARY OF THE INVENTION

The present invention remedies the drawbacks discussed hereinabove by a method for automatically composing a composed Web service having predetermined inputs and outputs from a set of component Web services stored in a database, each comprising at least one input and at least one output associated with textual representations, characterized in that it comprises a selection of a component service having outputs semantically corresponding to all the predetermined outputs, a selection of a component service having all the inputs semantically corresponding to predetermined inputs, and a composition of the composed service with the selected component services.

According to a simple composed service composition, the selected component service that has outputs semantically corresponding to all the predetermined outputs can also be the one that has all the inputs semantically corresponding to predetermined inputs. However, in practice, frequently, the selected component service that has outputs semantically corresponding to all the predetermined outputs is distinct from the selected component service that has all the inputs semantically corresponding to predetermined inputs.

The semantic mapping is a subsumption between concepts defining inputs and outputs of at least two services. In particular, outputs of a component service correspond semantically to all the predetermined outputs when each of said outputs of the component service are subsumed by at least one of the predetermined outputs, and all the inputs of a component service correspond semantically to predetermined inputs when each of said all the inputs of the component service subsumes at least one of the predetermined inputs.

Generally, the composed service comprises more than two available selected component services. The composition of the composed service is then an ordered sequence of a plurality of component services selected from the set of component services, all the inputs of the first component service of the composed service semantically corresponding to predetermined inputs of the composed service, all the inputs of each of the other component services of the composed service semantically corresponding to outputs of the component service preceding them in the composed service, and the outputs of the last component service of the composed service semantically corresponding to all the predetermined outputs of the composed service.

Unlike the known techniques which establish a point-to-point composition by a semantically close mapping of each input of a service to an output of another service, the method of the invention has the advantage of establishing a composed service with a minimum of available component Web services by maximizing the mapping of all the inputs of a service to outputs of another service. In other words, all the inputs of each component service of the composed service semantically correspond to outputs of the component service preceding it in the composed service. Thanks to the semantic mappings between the sets of output and input concepts of component services in the composed service, the number of component services involved in composing a composed service according to the invention is generally less than that for the composition of a composed service according to the prior art, which reduces the risk of composing a composed service with a high number of services which is intrinsically complex and highly inoperable.

The semantic mapping between two component services is a subsumption associating all the inputs of a component service to outputs of the component service that precedes it in the composed service. In other words, all the inputs of a given component service semantically correspond to outputs of another component service preceding it in the composed service when each of said all the inputs of the given component service subsumes at least one of the outputs of the other component service. A concept associated with an output is said to be subsumed by a concept associated with an input when the input concept accepts a wider significance than the output concept. The inputs/outputs of the services can belong to at least one predefined ontology defining semantic mappings.

So as to implement the semantic mapping between successive component services in a composed service, the composition of the composed service can comprise:

a selection by recursive loop of component services, outputs of each component service selected in an increasing recurrence of the recursive loop semantically corresponding to the inputs of the component service selected on the preceding recurrence of the recursive loop, the outputs of the first selected component service semantically corresponding to the predetermined outputs of the composed service,

a composition of the composed service when the inputs of the component service selected in the last increasing recurrence of the recursive loop semantically correspond to inputs of the composed service, and

an insertion by decreasing recurrence of the recursive loop of each of the component services previously selected in the composed service.

For a given composed service, the method can comprise a composition of a plurality of different composed services, each including at least one component service, all the inputs of each composed service semantically corresponding to predetermined inputs, and outputs of each composed service semantically corresponding to all the predetermined outputs.

Another object of the invention is a platform for automatic composition of a composed Web service having predetermined inputs and outputs from a set of component Web services stored in a database each comprising at least one input and at least one output associated with textual representations. The platform is characterized in that it comprises means for selecting a component service having outputs semantically corresponding to all the predetermined outputs, means for selecting a component service having all the inputs semantically corresponding to predetermined inputs, and means for composing the composed service with the selected component services.

Finally, the invention relates to a computer program able to be implemented in the platform for automatic composition of a composed Web service having predetermined inputs and outputs from a set of component Web services stored in a database each comprising at least one input and at least one output associated with textual representations, said program comprising instructions which, when the program is run in the platform, perform the steps in accordance with the method of the invention.

### BRIEF DESCRIPTION OF THE DRAWINGS

Other characteristics and advantages of the present invention will become more clearly apparent from reading the following description of several embodiments of the invention given as nonlimiting examples, with reference to the corresponding appended drawings in which:

FIG. 1 is a schematic block diagram of a service chart relating to a known service composition method;

FIG. 2 is a schematic block diagram of a service composition platform according to the invention;

FIG. 3 is an algorithm of a method of searching for semantic mapping between two services according to the invention;

FIG. 4 is an algorithm of a service composition method according to the invention;

FIGS. 5a to 5e are taxonomy diagrams illustrating an exemplary application of the invention;

FIG. 6 represents blocks representing a set of services according to the exemplary application of the invention; and

FIG. 7 is a block representing a service to be composed according to the exemplary application of the invention.

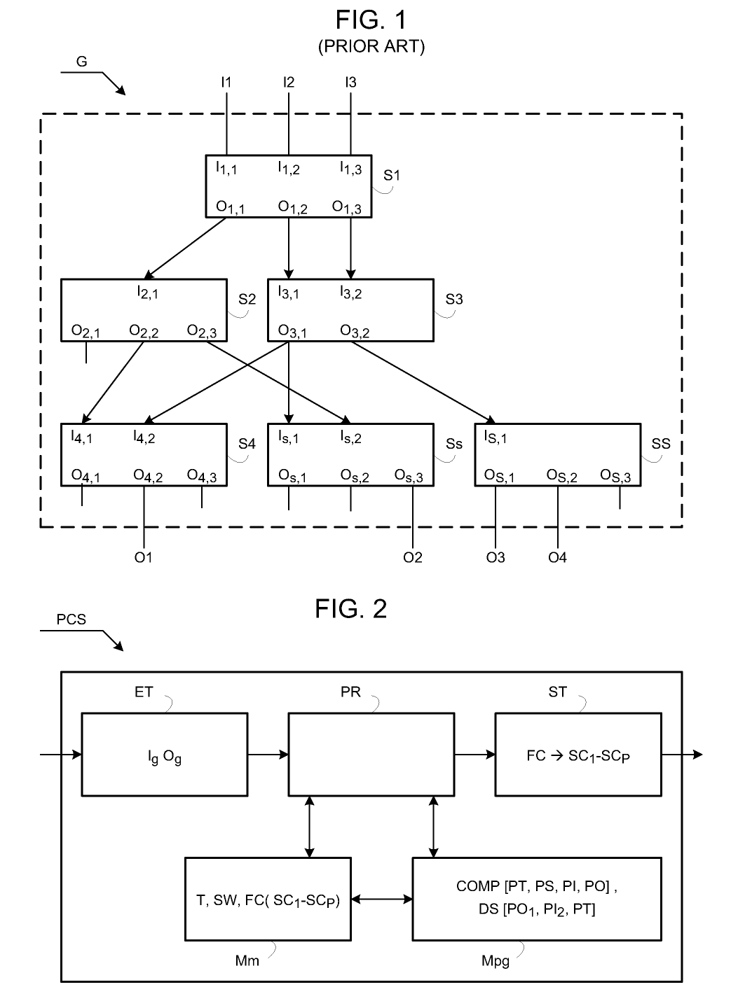

### DESCRIPTION OF EMBODIMENTS

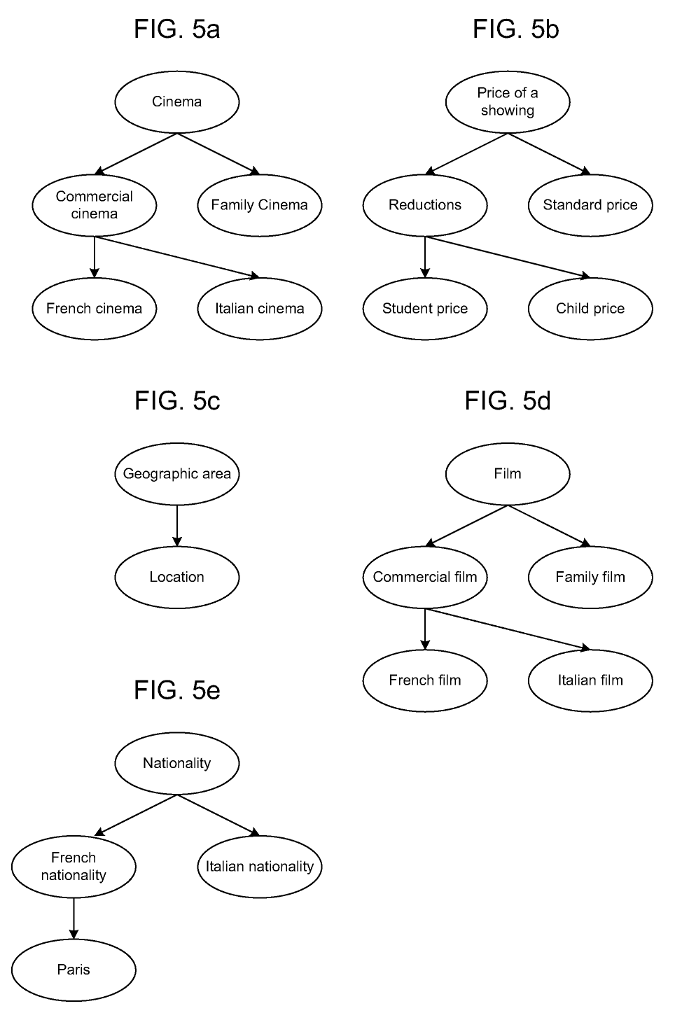

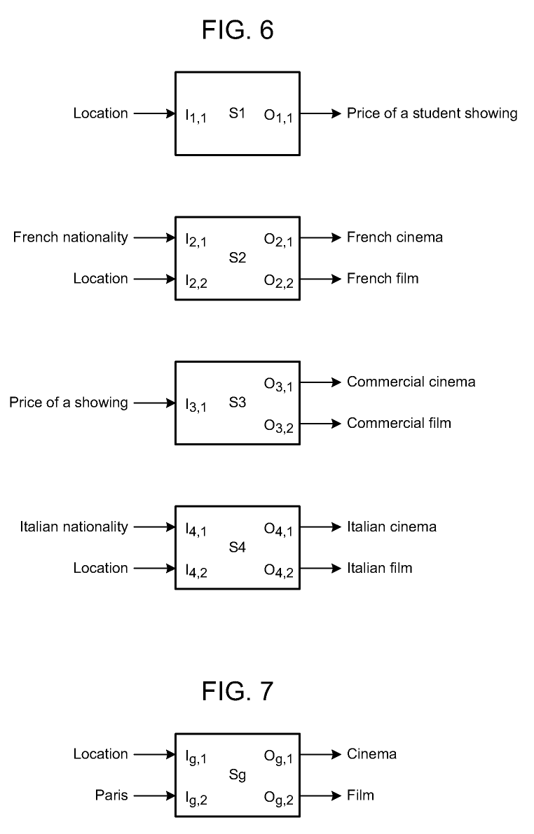

In order to assist in understanding the invention, the description is illustrated by a concrete application relating to the semantic domain of the cinema. The Web services S1 to S4 and Sg of FIGS. 6 and 7 comprise semantic information divided up into input concepts and output concepts relating to the semantic domain of the cinema. These concepts are connected according to ontologies represented in FIGS. 5a-5e. Domains other than the cinema can be applied to the invention.

Referring to FIG. 2, a platform for composing Web services PCS, such as a Web server handling Web services according to a semantic Web specification, comprises a memory Mm, a processing unit equipped, for example, with at least one processor PR driven by computer programs written in a memory Mpg and corresponding to algorithms implementing the service composition method of the invention. An input module ET and an output module ST such as communication interfaces are respectively positioned at the input and output of the processing unit PR.

A client Web service Sg to be composed according to the invention in the service composition platform is requested by a client terminal which transmits to the input module ET an input concept set Ig known to the client and an output concept set Og desired by the client, these two predetermined sets defining the service Sg. As shown in FIG. 7, the service Sg comprises inputs I_{g,1} and I_{g,2}, each respectively associated with the input concepts “Location” and “Paris”, and also comprises outputs O_{g,1} and O_{g,2} respectively associated with the output concepts “Cinema” and “Film”. The client terminal can also transmit an identifier of the associated semantic domain.

The memory Mm of the platform PCS is, for example, a database containing a set SW of available services, that is, services made available to a client, the input concepts and the output concepts of which relate to a specific semantic domain and are connected to each other according to a set of ontologies T stored in the memory Mm. According to the exemplary application relating to the semantic domain of the cinema, the set SW comprises, among others, the services S1 to S4 represented in FIG. 6.

In reality, the set of available services SW comprises a very large number of services.

The memory Mm also comprises a file FC including various composed services SC₁ to SCₚ determined after executing the method of the invention and transmitted to the client terminal from the output module ST. One of these composed services, SCₚ, with 1≦p≦P, is selected either by the processing unit PR, or by the client according to particular conditions, and corresponds to the requested service Sg.

A composed service is based on one or more of the available services of which it is composed. When the composed service obtained from the composition comprises several component services, the first service in the composed service has all its input concepts corresponding semantically to input concepts Ig desired by the client, and the last component service in the composed service has output concepts corresponding semantically to all the output concepts Og desired by the client.

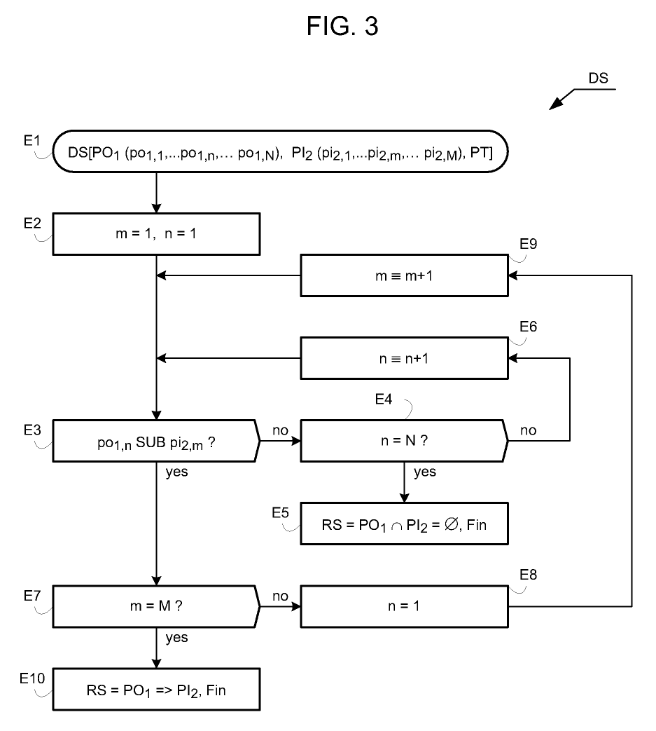

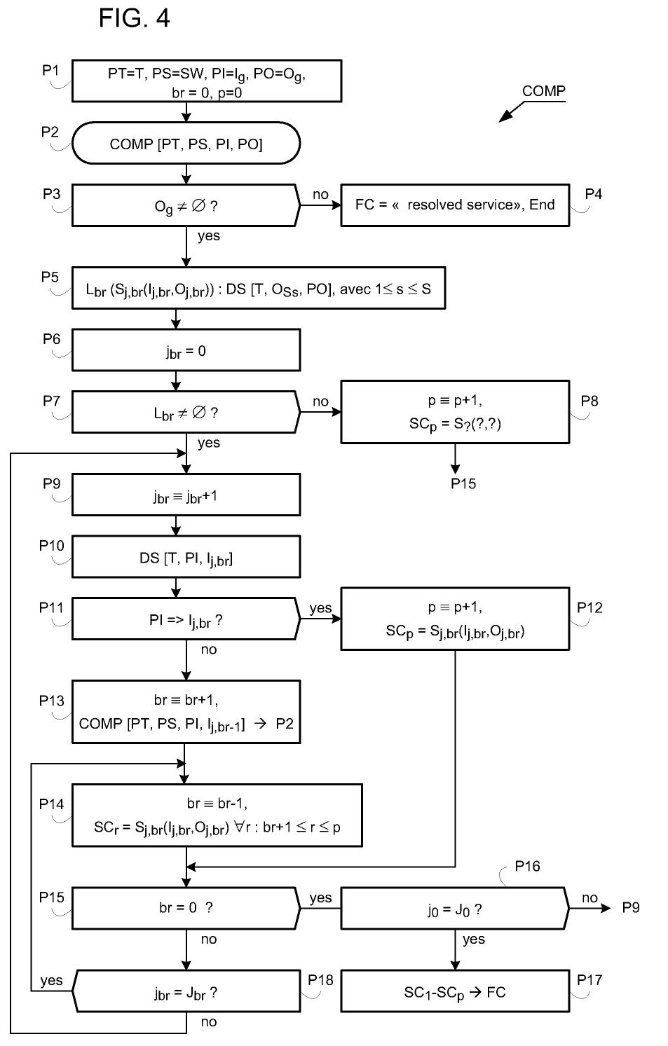

The memory Mpg comprises algorithms DS and COMP of the service composition method of the invention, executed by the processing unit PR and described in more detail with reference to FIGS. 3 and 4.

The algorithm DS tests the semantic mapping between the output concepts of a first service constituting a set of outputs O₁ and all the input concepts of a second service constituting a set of inputs I₂ according to the set of ontologies T.

The algorithm COMP establishes one or more composed services SCₚ, with 1≦p, from the set of services SW and from the set of ontologies T, by using the algorithm DS. A composed service SCₚ corresponds to the service Sg to be composed and comprises, as the input concept set, the set Ig transmitted by the client, and, as the output concept set, the set Og also transmitted by the client. A composed service is an ordered sequence of component Web services linked by semantic mapping. In a particular case, a composed service SCₚ can include just one available Web service.

Referring to FIG. 3, the algorithm DS comprises steps E1 to E10.

The step E1 defines input parameters of the algorithm DS which relate to a set PO₁ of output concepts po_{1,1}-po_{1,N} of a first service, a set PI₂ of input concepts pi_{2,1}-pi_{2,M} of a second service and a set PT of the ontologies linking the various sets PO₁ and PI₂ of concepts. By executing the algorithm DS, the processing unit PR tests the semantic mapping between the output concepts po_{1,1}-po_{1,N} and the input concepts pi_{2,1}-pi_{2,M}. The values of the parameters PO₁, PI₂ and PT are assigned in the algorithm COMP on calling the algorithm DS.

In the step E2, the indices n and m of the concepts po_{1,n} and pi_{1,m} with 1≦n≦N and 1≦m≦M are initialized, for example at “1”, in order to begin a semantic mapping test between the first two input and output concepts po_{1,1} and pi_{1,1}.

In a loop of iterative steps E3 to E6, the processing unit PR tests the semantic mapping between an input concept pi_{2,m} and an output concept po_{1,n} and increments the index n by one unit in the step E6. If the output concept po_{1,n} is not subsumed (SUB operator) by the input concept pi_{2,m}, that is, if the output concept po_{1,n} does not semantically correspond to the input concept pi_{2,m}, in the step E3, and if all the output concepts have not yet been compared to the input concept pi_{2,m}, that is, if the index n is less than N in the step E4, then another output concept po_{1,n+1} is compared to the input concept pi_{2,m}, in a new iteration of the loop E3 to E6.

In the steps E3 and E4, if all the output concepts po_{1,1}-po_{1,N} have been compared to the input concept pi_{2,m}, and no output concept is subsumed by the concept pi_{2,m}, then the algorithm DS delivers a Boolean result RS=PO₁∩PO₂=Ø indicating that no semantic mapping links the set PO₁ of the output concepts of the first service to the set PI₂ of the input concepts of the second service. The processing unit PR stops the algorithm DS, which is indicated by “End” in the step E5.

If, in the step E3, the output concept po_{1,n} is subsumed by the input concept pi_{2,m}, and other input concepts are still to be tested, that is, if the index m is less than M in the step E7, the processing unit PR executes at most N new iterative loops E3 to E6 to test the semantic mapping between all the output concepts po_{1,1} to po_{1,N} and another input concept pi_{2,m+1}. In other words, the unit PR initializes at “1” the index n of the output concepts in the step E8, and increments by one unit the index m relating to the input concepts in the step E9.

If all the input concepts pi_{2,1}-pi_{2,M} of the second service are subsumed by output concepts of the set PO₁ of the first service in the step E7, the algorithm produces a Boolean result RS=PO₁=>PI₂ indicating that the set PI₂ of input concepts of the second service corresponds semantically to the set PO₁ of output concepts of the first service. The processing unit terminates the algorithm DS, indicated by “End” in the step E10.

In the step E3, the semantic mapping test between an input concept pi_{2,m} and an output concept po_{1,n} is a subsumption SUB and relates to the taxonomy of the ontology T. The output concept po_{1,n} is said to be subsumed by the input concept pi_{2,m} when the input concept pi_{2,m} accepts a wider significance than the output concept po_{1,n} and includes it. For example, referring to the taxonomy represented in FIG. 5a, the input concept pi_{2,m}, “Cinema”, subsumes the output concept po_{1,n}, “Commercial cinema”. The converse is not true: the concept po_{1,n}, “Cinema”, does not subsume the concept pi_{2,m}, “Commercial cinema”, which is a more specific concept.

A set O₁ of N output concepts of a first service is subsumed by a set I₂ of M input concepts of a second service, regardless of the combination of integers M and N: M=N, or M<N, or M>N.

Referring to FIG. 4, the algorithm COMP relating to the composition of a composed client service Sg and executed by the processing unit PR comprises steps P1 to P18.

The algorithm COMP determines at least one composed service SCₚ of ordered Web services, stored in a file FC. Each available Web service of which the composed service SCₚ is composed is selected in a recurrence br of a recursive loop from the available Web services of the set SW, the selection being made in a decreasing manner from the last service to the first service of which the composed service is composed. The last Web service of the composed service is first selected on the first recurrence br=0 of the recursive loop according to the sets of input concepts Ig and output concepts Og transmitted by the client. The other Web services of which the composed service is composed are selected successively on executions of increasing recurrences of the recursive loop. Each other component service is selected according to the input concept set Ig transmitted by the client and the input concept set of the service selected on the preceding recurrence br−1 of the recursive loop. As soon as the input concept set of the selected service corresponds semantically to the set Ig, the selected service is considered to be the first service of which the composed service is composed. The services of which the composed service is composed are then ordered from the last selected service corresponding to the first service of the composed service to the first selected service corresponding to the last service of the composed service. A plurality of composed services can be established for the same sets Ig and Og and stored in the file FC. A composed service can also comprise just one available Web service.

The step P2 of the algorithm defines input parameters of the algorithm COMP which are: PT, an ontology set of the semantic domain being processed, PS, a known set of available services, PI, an input concept set defining the service to be composed, and PO, an output concept set defining the service to be selected.

The parameters PT, PS, PI and PO are initialized, in the step P1, on receipt by the input module ET of data transmitted by the terminal of the client wishing to obtain a service Sg in return. The data contains, among other things, the input concept set Ig assigned to the parameter PI of the algorithm COMP and the output concept set Og assigned to the parameter PO in the initial recursive loop br=0 of the algorithm COMP. The parameter PT is initialized with the ontology set T included in the memory Mm, and the parameter PS is initialized with the service set SW included in the memory Mm. Also in the step P1, the index p is a pointer differentiating each determined composed service SCₚ, and is initialized at 0.

In the step P3, the processing unit PR checks that the output concept set PO is not empty. If the set PO is empty, the processing unit PR saves in the file FC a note indicating that “the service is resolved” since no output concept Og is requested, and terminates the algorithm COMP as indicated by “End”, in the step P4.

Otherwise, if the set PO is not empty, the processing unit PR creates a list L_{br} which is initially empty comprising services S_{1,br} to S_{J,br} of the set PS=SW, in the step P5. On each call to the recursive loop br, a new list L_{br} is created and may or may not include other services S_{1,br} to S_{J,br}. For each available Web service Sₛ in the set SW, with 1≦s≦S, the processing unit PR uses the algorithm DS to test the semantic mapping between the output concept set O_{Ss} of the service Sₛ and the concept set PO. The input parameters of the algorithm DS are: PT=T, the ontology set, PO₁=O_{Ss}, the output concept set of the service Sₛ, and PI₂=PO, the concept set which is, in the initial recurrence br=0 of the recursive loop, the output concept set O_{g} considered in this case to be an input concept set of another service. For each tested service Sₛ, if all the output concepts of the set PO correspond semantically to the output concepts of the service Sₛ, that is, subsume the output concepts of the service Sₛ, then the service Sₛ is saved in the list L_{br}. Thus, for the initial recurrence br=0, the output concept set Og desired by the client is satisfied by all the services S_{1,0} to S_{J,0} of the list L₀.

In the step P7, the processing unit PR checks the content of the list L_{br}. If the list L_{br} is empty, in the step P8, the processing unit PR increments by one unit the index p and incorporates in the composed service SCₚ a first abstract Web service S_{?}(?,?) indicating that the composed service has no solution in this context. Then, the processing unit continues to execute the algorithm COMP in the step P15.

In the step P7, if the list L_{br} is not empty, the processing unit PR increments the index j_{br} to select the service S_{j,br} from the j_{br} Web services in the list L_{br} in the step P9, the index j_{br} being previously set to 0 in the step P6. In the step P10, the processing unit PR uses the algorithm DS to test the semantic mapping between the input concept set I_{j,br} of the selected service S_{j,br} and the set PI relating to the input concept set Ig desired by the client. The input parameters of the algorithm DS are: PT=T, the ontology set, PO₁=PI, the input concept set of the service Sg, and PI₂=I_{j,br}.

In the simplest case, in the step P11, if the result RS of the algorithm DS indicates that the set I_{j,br} corresponds semantically to the set PI, the processing unit PR increments by one unit the index p and incorporates in the new composed service SCₚ the selected Web service S_{j,br} as the first service of the composed service, in the step P12.

Otherwise, in the step P11, if the result RS of the algorithm DS indicates that the set I_{j,br} does not correspond semantically to the set PI, the recursivity index br is incremented by one unit, and the processing unit PR recursively calls the algorithm COMP from the step P2 according to the input parameters: PT=PT, PS=PS, PI=PI and PO=I_{jbr-1}, in the step P13. In other words, only the parameter PO changes and concerns the output concept set of the service to be selected in the new recurrence br corresponding to the input concept set I_{jbr-1} of the service selected on the preceding recurrence br−1. The algorithm COMP is executed again with different input parameters, and another list L_{br} is created in the step P5, the content of which is checked in the step P7. The recursivity ends when the processing unit executes the step P7 or P14 and creates a composed service Scₚ by incrementing the index p and inserting a first abstract service S_{?}, or previously selected service S_{j,br} in the step P11 of the current recurrence br.

In the steps P15 and P18, if the recursivity index br is not zero and if all the J_{br} services of the list L_{br} have been selected, the processing unit PR terminates the current recurrence, in the step P18, and is directed to the preceding recurrence br−1, in the step P14. The processing unit PR decrements by one unit the recursivity index br and inserts the selected Web service S_{j,br} into the service or services SCᵣ composed in the preceding steps P8 and/or P12, for any index r between the values br+1 and p. Thus, the processing unit inserts an identical service S_{j,br} for all the composed services that have a part of first component services different from the input concept set Ig of the client composed service Sg, and that have one or more last component services identical to the output concept set Og of the service Sg.

In the steps P15 and P16, if the recursivity index br is zero and if all the services of the list L₀ have been selected, the processing unit PR stores the composed service or services Sc₁ to Scₚ in the file FC in the step P17. The unit PR stops the algorithm COMP.

In the steps P16 and P18, if the services of the list L_{br} have not yet been selected, the processing unit PR returns to the step P9 and selects another service from the list L_{br} by incrementing by one unit the index j_{br}. This new selection implies composing a new composed service in the step P8 or in the step P12, by incrementing by one unit the index p.

In the step P9, the selection of the services of a composed service is done in a decreasing manner from the last service to the first service of the composed service by incrementing the recursivity index br. Conversely, the ordered insertion of the services into the composed service is done in an increasing manner from the first service, in the steps P8 or P12, to the last service of the composed service by decrementing the recursivity index br in the step P14.

Before saving the file FC in the memory Mm, the processing unit deletes the composed services that do not contain a solution, that is, the composed services in which the first service is an abstract service S_{?}.

Before transmitting the file FC to the client terminal from the output entity ST, the processing unit PR can preselect the composed services to be transmitted to the client, for example the composed services comprising a minimum number of component Web services.

In the exemplary application relating to the semantic domain of the cinema, the data defining the client composed service Sg and received by the entity ET are: IG=“Location”, “Paris”, and Og=“Cinema”, “Film”. The service set SW comprises S services, including the services S1 to S4 represented in FIG. 6. The input and output concepts of the services S1, S2, S3 and S4 are:

### I_{S1}=“Location”;

O_{S1}=“Price of a student showing”;
Iₛ₂=“French nationality”, “Location”;
Oₛ₂=“French cinema”, “French film”;
I_{S3}=“Price of a showing”;
O_{S3}=“Commercial cinema”, “Commercial film”;
I_{S4}=“Italian nationality”, “Location”;
O_{S4}=“Italian cinema”, “Italian film”.

The ontology set T linking the various concepts of these services is represented in FIGS. 5a to 5e.

In the initial recurrence br=0, in the step P2, the processing unit uses the algorithm COMP[T, SW, Ig, Og], and checks, in the step P3, the content of the set PO: PO=“Cinema”, “Film” not being empty.

In the step P5, the processing unit searches in the set SW for the services whose output concept sets are subsumed by the output concept set Og and thus creates the list L₀=S2, S3, S4, by S iterative calls to the algorithm DS. The service S1 is excluded from the list L₀ since its output concept is not subsumed in the set Og.

In the step P9, the processing unit selects the first service S2 of the list L₀ and proceeds to test the semantic mapping by calling the algorithm DS[T, I_{g}, I_{S2}], in the step P10. The algorithm DS returns, in the step P11, a result indicating that the set Ig corresponds semantically to the set I_{S2}. The processing unit PR composes a composed service SC₁ and inserts therein the service S2: SC₁=S2, in the step P12.

In the steps P15 and P16, the recursivity index br is zero and services of the list L₀ have not been selected. The processing unit PR then returns to the step P9 to select the second service S3 of the list L₀. The processing unit PR carries out the semantic mapping test by calling the algorithm DS[T, I_{g}, I_{S3}], in the step P10. The algorithm DS returns, in the step P11, a result indicating that the set I_{g} does not correspond semantically to the set I_{S3}.

In the step P13, the processing unit increments by one unit the recursivity index, or br=1, and uses the algorithm COMP[T, SW, I_{g}, I_{S3}].

In the step P5, the processing unit creates the list L₁ which is composed only of the service S1, the output concept set of which is subsumed by the input concept set of the service S3.

In the step P9, the processing unit selects the first service S1 of the list L₁ and carries out the semantic mapping test by calling the algorithm DS[T, I_{g}, I_{S1}], in the step P10. The algorithm DS produces, in the step P11, a result indicating that the set Ig corresponds semantically to the set I_{S1}. The processing unit PR composes a composed service SC₂ and inserts therein the service S1: SC₂=S1, in the step P12.

In the steps P15 and P18, the recursivity index br is not zero and all the services of the list L₁ have been selected. The processing unit PR leaves the current recurrence, in the step P18, and continues in the preceding recurrence br=0 to add to the composed service SC₂ the service S3: SC₂=S1, S3, in the step P14.

In the steps P15 and P16, the recursivity index br is zero and only the service S4 of the list L₀ has not been selected. The processing unit PR returns to the step P9 to select the service S4. The processing unit PR carries out the semantic mapping test by calling the algorithm DS[T, I_{g}, I_{S4}], in the step P10. The algorithm DS produces, in the step P11, a result indicating that the set Ig does not correspond semantically to the set I_{S4}.

In the step P13, the processing unit increments by one unit the recursivity index br=1 and calls the algorithm COMP[T, SW, I_{g}, I_{S4}].

In the step P5, the processing unit creates the empty list L₁. Then, in the step P8, the processing unit PR creates a composed service SC₃ and inserts therein the abstract service S_{?}: SC₃=S_{?}.

In the steps P15 and P18, the recursivity index br is not zero and the list L₁ is empty. The processing unit PR leaves the current recursive loop, in the step P18, and continues the preceding recurrence br=0 to add to the composed service SC₃ the service S4: SC₃=(S_{?}, S4), in the step P14.

In the steps P15 and P16, the recursivity index br is zero and all the services of the list L₀ have been selected. The processing unit PR stores the composed services SC₁ to SC₃ in the file FC, in the step P17. The unit PR has terminated the algorithm COMP.

The platform PFC incorporates, or can access locally or via a telecommunication network, a database of the type of those used in artificial intelligence. The platform PFC can be an electronic telecommunication device or object personal to the user of the method, for example a communicating personal digital assistant PDA. It can also, for example, be any other domestic terminal, portable or otherwise, such as a video games console, or an intelligent television receiver cooperating with a remote control with display or alphanumeric keyboard acting also as a mouse via an infrared link.

The invention described here relates to a service composition method and platform. According to one implementation, the steps of the method of the invention are determined by the instructions of a computer program incorporated in the platform, such as a server. The program includes program instructions which carry out the steps of the method according to the invention when said program is executed in a processor of the platform, whose operation is then controlled by the execution of the program.

Consequently, the invention also applies to a computer program, in particular a computer program stored on or in a storage medium readable by a computer and by any data processing device adapted to implement the invention. This program can use any programming language and take the form of source code, object code or an intermediate code between source code and object code, such as a partially compiled form, or any other form desirable for implementing the method according to the invention.

The storage medium can be any entity or device capable of storing the program. For example, the medium can include storage means in which the computer program according to the invention is stored, such as a ROM, for example a CD ROM or a microelectronic circuit ROM, a USB key, or magnetic storage means, for example a diskette (floppy disk) or a hard disk.

Moreover, the information medium can be a transmissible medium such as an electrical or optical signal, which can be routed via an electrical or optical cable, by radio or by other means. The program according to the invention can in particular be downloaded over an Internet type network.

Alternatively, the information medium can be an integrated circuit in which the program is incorporated, the circuit being adapted to execute or to be used in the execution of the method according to the invention.

What we claim is:

1. A method for automatically composing a composed Web service having predetermined inputs and outputs from a set of component Web services stored in a database, each component Web service comprising at least one input and at least one output associated with textual representations, said method comprising selecting a component service having outputs semantically corresponding to all the predetermined outputs, selecting a component service having all the inputs semantically corresponding to predetermined inputs, and composing said composed service with the selected component services.

2. A method according to claim 1, wherein outputs of a component service correspond semantically to all the predetermined outputs when each of said outputs of the component service are subsumed by at least one of said predetermined outputs, and all the inputs of a component service correspond semantically to predetermined inputs when each of said all the inputs of the component service subsumes at least one of said predetermined inputs.

3. A method according to claim 1, wherein said composed service is an ordered sequence of a plurality of component services selected from said set of component services, all the inputs of a first component service of said composed service semantically corresponding to predetermined inputs of said composed service, all the inputs of each of the other component services of the composed service semantically corresponding to outputs of the component service preceding them in said composed service, and the outputs of a last component service of said composed service semantically corresponding to all said predetermined outputs of said composed service

4. A method according to claim 3, wherein composing said composed service comprises:
selecting by recursive loop of component services, outputs of each component service selected in an increasing recurrence of said recursive loop semantically corresponding to the inputs of the component service selected on the preceding recurrence of said recursive loop, the outputs of a first selected component service semantically corresponding to said predetermined outputs of said composed service,
composing said composed service when the inputs of the component service selected in a last increasing recurrence of said recursive loop semantically correspond to inputs of said composed service, and
inserting by decreasing recurrence of said recursive loop each of said component services previously selected in said composed service.

5. A method according to claim 3, wherein all the inputs of a given component service semantically correspond to outputs of another component service preceding said given component service in the composed service when each of said all the inputs of said given component service subsumes at least one of said outputs of said other component service.

6. A method according to claim 1, comprising a composing a plurality of different composed services, each composed service including at least one component service, all the inputs of each composed service semantically corresponding to predetermined inputs, and outputs of each composed service semantically corresponding to all said predetermined outputs.

7. A method according to claim 1, wherein said inputs and outputs of said services belongs to at least one predefined ontology defining semantic mappings.

8. A platform for automatic composition of a composed Web service having predetermined inputs and outputs from a set of component Web services stored in a database, each component Web service comprising at least one input and at least one output associated with textual representations, said platform comprising means for selecting a component service having outputs semantically corresponding to all the predetermined outputs, means for selecting a component service having all the inputs semantically corresponding to predetermined inputs, and means for composing said composed service with the selected component services.

9. A computer arrangement performed in a platform for automatic composition of a composed Web service having predetermined inputs and outputs from a set of component Web services stored in a database, each component Web service comprising at least one input and at least one output associated with textual representations, said computer arrangement including instructions adapted for selecting a component service having outputs semantically corresponding to all the predetermined outputs, selecting a component service having all the inputs semantically corresponding to predetermined inputs, and composing said composed service with the selected component services.
